(19) United States
(12) Patent Application Publication
(10) Pub. No.: US 2007/0005822 A1
(43) Pub. Date: Jan. 4, 2007

(54) INTERFACE APPARATUS AND INTERFACE METHOD

(75) Inventors: Daisuke Yamamoto, Kyoto-fu (JP); Miwako Doi, Kanagawa-ken (JP); Yosuke Tajika, Hyogo-ken (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/426,714

(22) Filed: Jun. 27, 2006

(30) Foreign Application Priority Data
Jul. 1, 2005 (JP) 2005-193968

(51) Int. Cl. G06F 3/00

(52) U.S. Cl. 710/15

(57) ABSTRACT

A signal acquisition unit acquires a status signal from a home appliance. An expression unit expresses the status signal to a user. A reaction acquisition unit acquires a reaction signal from the user in response to the status signal expressed. A registration unit registers relativity in the status signal and the reaction signal in a storage unit. A first comparison unit compares an acquired status signal by the signal acquisition unit to the stored status signal in the storage unit. If the acquired status signal matches the stored status signal, the expression unit expresses the reaction signal related to the stored status signal. If the acquired status signal does not match the stored status signal, the expression unit expresses the acquired status signal, and the registration unit registers relativity in the acquired status signal and a reaction signal from the user in response to the acquired status signal expressed.

### CROSS-REFERENCE TO RELATED APPLICATIONS

This application is based upon and claims the benefit of priority from prior Japanese Patent Application No. 2005-193968, filed on Jul. 1, 2005; the entire contents of which are incorporated herein by reference.

### FIELD OF THE INVENTION

The present invention relates to an interface between a user and an information home appliance, and a related method.

### BACKGROUND OF THE INVENTION

Recently, development for a home network using an information home appliance (home electric device) progresses. The information home appliance having many convenient functions is composed for a user to variously utilize. However, the user must select his/her desired function from many functions. In case of not finding the desired function, it is inconvenient for the user.

Accordingly, up to the present, an interface apparatus between the information home appliance and the user is taken into consideration. For example, an interface apparatus preparing a dictionary in which the user's operation by speech or gesture and the meaning contents of the operation are edited by each user is disclosed (Japanese Patent Disclosure (Kokai) No. 2002-251235).

Furthermore, by using a directory service such as UPnP (Universal Plug and Play) or UDDI (Universal Description Discovery and Integration), an apparatus for presenting functions of the home electric device to the user (client device) is disclosed (United States Patent Application Publication No. 2002/0035621 A1).

Furthermore, in case that a plurality of client devices cooperatively has a plurality of functions, the client device for presenting contents of this cooperative function to the user is disclosed (Japanese Patent Disclosure (Kokai) 2004-320747). In this case, the client device functions as the interface apparatus.

However, a function of the home electric device is described by a designer's original rule. Accordingly, even if the interface apparatus realizes the function as it is, the user cannot usually understand the function.

Furthermore, in order to convert the function to the user's understandable expression, the interface apparatus must previously have had a dictionary installed including an expression corresponding to each function. In this case, the designer takes much time for designing the interface apparatus, and this hinders general-use of the interface apparatus. For example, the designer must install a dictionary related with a predetermined home electric device onto the interface apparatus, and this interface apparatus can be utilized for the predetermined home electronic device only.

### SUMMARY OF THE INVENTION

The present invention is directed to an interface apparatus and an interface method for a user to easily operate an information home appliance and understand a status of the information home appliance.

According to an aspect of the present invention, there is provided an interface apparatus for communicating with a home appliance, comprising: a signal acquisition unit configured to acquire a status signal representing an operation status of the home appliance; an expression unit configured to presentably express the status signal to the user by the user's recognizable method; a reaction acquisition unit configured to acquire a reaction signal by converting the user's reaction in response to the status signal expressed; a registration unit configured to register relativity in the status signal and the reaction signal; a storage unit configured to store the status signal and the reaction signal with the relativity; and a first comparison unit configured to compare an acquired status signal by said signal acquisition unit to the stored status signal in said storage unit; wherein, if the acquired status signal matches the stored status signal, said expression unit presentably expresses the reaction signal related to the stored status signal to the user, and wherein, if the acquired status signal does not match the stored status signal, said expression unit presentably expresses the acquired status signal to the user, and said registration unit registers relativity in the acquired status signal and a reaction signal from the user in response to the acquired status signal expressed.

According to another aspect of the present invention, there is also provided a method for communicating with a home appliance, comprising: acquiring a status signal representing an operation status of the home appliance; presentably expressing the status signal to the user by the user's recognizable method; acquiring a reaction signal by converting the user's reaction in response to the status signal expressed; registering relativity in the status signal and the reaction signal; storing the status signal and the reaction signal with the relativity in a memory; comparing an acquired status signal to the stored status signal in the memory; presentably expressing the reaction signal related to the stored status signal to the user if the acquired status signal matches the stored status signal; presentably expressing the acquired status signal to the user if the acquired status signal does not match the stored status signal; and registering relativity in the acquired status signal and a reaction signal from the user in response to the acquired status signal expressed.

According to still another aspect of the present invention, there is also provided a computer program product, comprising: a computer readable program code embodied in said product for causing a computer to communicate with a home appliance, said computer readable program code comprising: a first program code to acquire a status signal representing an operation status of the home appliance; a second program code to presentably express the status signal to the user by the user's recognizable method; a third program code to acquire a reaction signal by converting the user's reaction in response to the status signal expressed; a fourth program code to register relativity in the status signal and the reaction signal; a fifth program code to store the status signal and the reaction signal with the relativity in a memory; a sixth program code to compare an acquired status signal to the stored status signal in the memory; a seventh program code to presentably express the reaction signal related to the stored status signal to the user if the acquired status signal matches the stored status signal; an eighth program code to presentably express the acquired status signal to the user if the acquired status signal does not match the stored status signal; and a ninth program code to register relativity in the acquired status signal and a reaction signal from the user in response to the acquired status signal expressed.

### BRIEF DESCRIPTION OF THE DRAWINGS

FIG. 1 is a schematic diagram of an interface system according to a first embodiment.

FIG. 2 is a block diagram of a robot 10 in FIG. 1.

FIG. 3 is a schematic diagram of the interface system in case of registering a status signal and a reaction signal.

FIG. 4 is a flow chart of registration processing of the status signal and the reaction signal according to the first embodiment.

FIG. 5 is a schematic diagram of the interface system in case of relating the status signal with the reaction signal.

FIG. 6 is a flow chart of relation processing of the status signal and the reaction signal according to the first embodiment.

FIG. 7 is a schematic diagram of the interface system in case of operating an information home appliance 20 in FIG. 1.

FIG. 8 is a flow chart of operation processing for the information home appliance 20 according to the first embodiment.

FIG. 9 is a block diagram of a robot 30 according to a second embodiment.

FIG. 10 is a flow chart of registration processing of the status signal and the reaction signal according to the second embodiment.

FIG. 11 is a flow chart of relation processing of the status signal and the reaction signal according to the second embodiment.

FIG. 12 is a flow chart of robot's operation in case of changing status of the information home appliance 20 according to the second embodiment.

FIG. 13 is a schematic diagram of an explanation description of a microwave oven as the information home appliance according to a third embodiment.

FIG. 14 is a schematic diagram of contents of the explanation description in FIG. 13.

FIG. 15 is a schematic diagram of the interface system in case of registering the status signal, the explanation description and the reaction signal according to the third embodiment.

FIG. 16 is a flow chart of operation processing of the status signal, the explanation description and the reaction signal according to the third embodiment.

FIG. 17 is a schematic diagram of a classification list according to a fourth embodiment.

FIG. 18 is a flow chart of registration operation of a kind signal, the status signal and the explanation description according to the fourth embodiment.

FIG. 19 is a schematic diagram of the classification list having kind data according to the fourth embodiment.

FIG. 20 is a schematic diagram of relationships with the robot, the explanation description, and the kind data.

FIG. 21 is a flow chart of operation processing of the interface system according to the fourth embodiment.

FIG. 22 is a schematic diagram of the interface system according to a fifth embodiment.

FIG. 23 is a flow chart of registration processing of a cooperation control signal, the explanation and the reaction signal according to the fifth embodiment.

FIG. 24 is a schematic diagram of the interface system in case of the robot's operation according to the fifth embodiment.

FIG. 25 is a flow chart of operation processing of the robot 10 according to the fifth embodiment.

### DETAILED DESCRIPTION OF THE EMBODIMENTS

Hereinafter, various embodiments of the present invention will be explained by referring to the drawings. The present invention is not limited to the following embodiments.

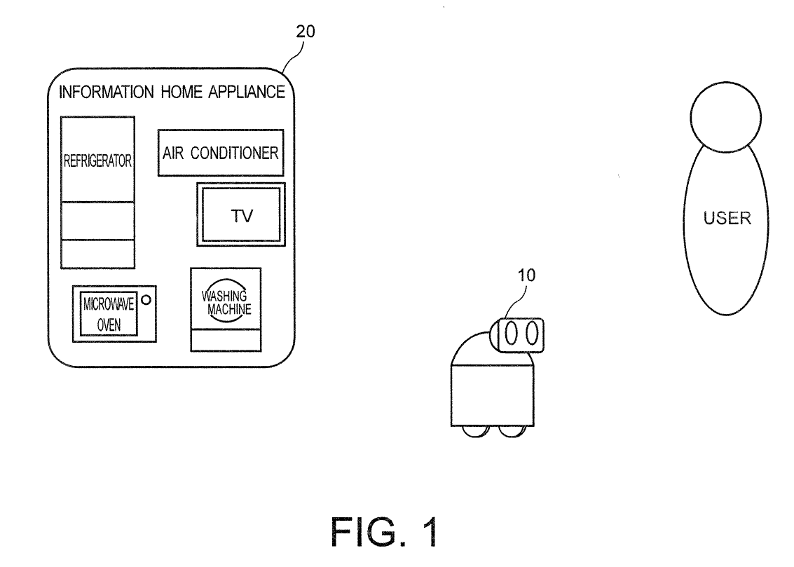

FIG. 1 is a schematic diagram of an interface apparatus, an information home appliance and a user according to a first embodiment. In the first embodiment, a robot 10 having a familiar body is used as the interface apparatus. The information home appliance 20 is a home electronic device such as an air conditioner, a refrigerator, a television, a washing machine, or a microwave oven. The information home appliance 20 changes its operation status based on a control command from the user or a network, or status change of its appliance, and outputs a status signal. The status signal is a signal representing the operation status of its appliance. By inputting the status signal from outside, the information home appliance 20 transitions to an operation status of the status signal. Furthermore, by outputting the status signal, the information home appliance 20 communicates to the robot 10 its own operation status. For example, when the user sets the air conditioner to “ON” status using a remote controller, the remote controller outputs a control command to activate the air conditioner. The air conditioner becomes under a status of “ON” by acquiring the control command, and outputs a status signal representing “ON” to the robot 10. The operation status means arbitrary status or operation of various information home appliances 20.

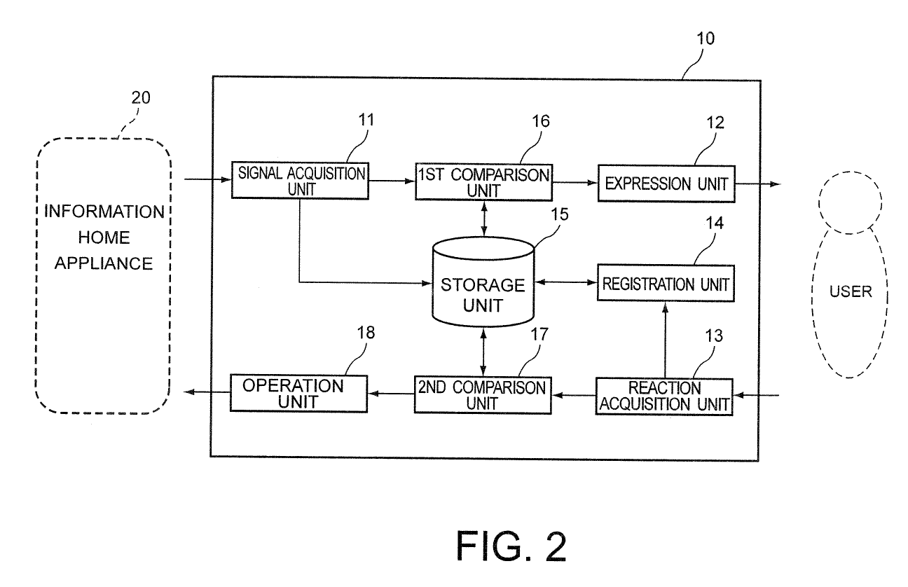

FIG. 2 is a block diagram of the robot 10. The robot 10 comprises a signal acquisition unit 11, an expression unit 12, a reaction acquisition unit 13, a registration unit 14, a storage unit 15, a first comparison unit 16, a second comparison unit 17, and an operation unit 18.

The signal acquisition unit 11 acquires a status signal output from the information home appliance 20. By using UPnP, the signal acquisition unit 11 can communicate with any of the information home appliances.

The expression unit 12 presentably expresses the status signal or a reaction signal stored in the storage unit 15 to the user. The expression method may be any arbitrary method for the user to recognize (speech, image, gesture, and so on). For example, in case of speech, the expression unit 12 may be a speaker. In case of image, the expression unit may be a display. In case of gesture, the expression unit 12 may be a mechanism such as a hand, a leg, or a face of the robot 10.

The reaction acquisition unit 13 acquires the user's reaction as a reaction signal in response to a notification from the expression unit 12. The reaction signal is an electric signal converted from the user's reaction. For example, when the expression unit 12 expresses the status signal as a speech, the user reacts with a voice in response to the speech. In this case, the reaction acquisition unit 13 may be a microphone. The microphone converts the user's voice as a reaction signal to an electric signal. If the user reacts with a gesture or a facial expression, the reaction acquisition unit 13 may be a camera. The camera converts the user's gesture or facial expression as a reaction signal to an electric signal.

The registration unit 14 relationally registers the status signal and the reaction signal. For example, the expression unit 12 expresses the status signal to the user, and after that, the reaction acquisition unit 13 acquires the user's reaction within predetermined period. The registration unit 14 relates the status signal with the reaction signal. As for relativity, the same identification number is assigned to the status signal and the reaction signal. The identification number may be a random number or a date or time.

The storage unit 15 relationally stores the status signal and the reaction signal. The storage unit 15 may be an arbitrary memory medium. However, a readable/writable memory medium is necessary.

The first comparison unit 16 compares the status signal stored in the storage unit 15 with another status signal acquired by the signal acquisition unit 11. The comparison means decides whether these reaction signals are the same.

The second comparison unit 17 compares the reaction signal stored in the storage unit 15 with another reaction signal acquired by the reaction acquisition unit 13. The comparison means decides whether these reaction signals are the same.

The operation unit 18 outputs the status signal stored in the storage unit 15 to the information home appliance 20. In response to the status signal, the information home appliance 20 changes its operation status.

The robot 10 can communicate with arbitrary information home appliance 20 via UPnP. However, the robot 10 need not previously prepare data of the information home appliance 20. Accordingly, the robot 10 does not have a dictionary related with the information home appliance 20.

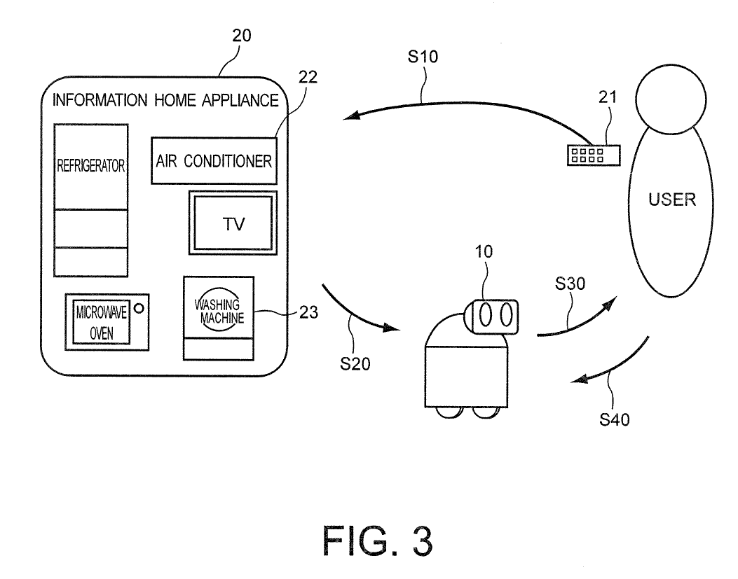

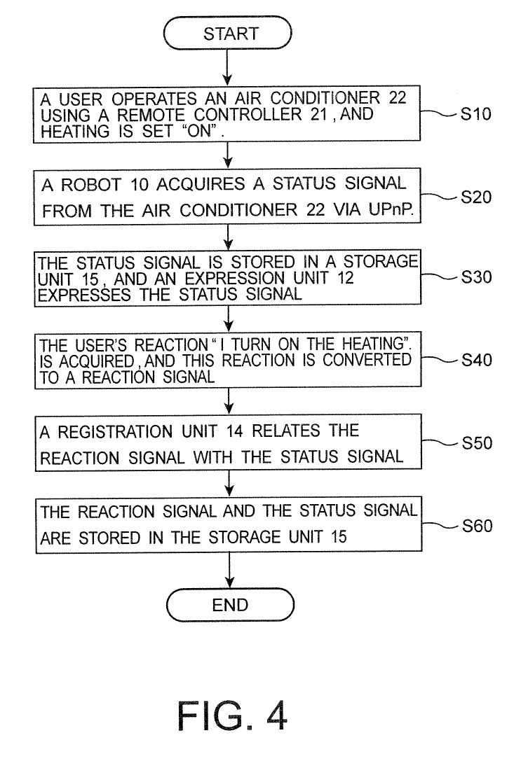

Hereinafter, a series of operations of the robot 10 are explained. FIG. 3 is a schematic diagram showing the robot's operation in case of registering the status signal and the reaction signal. FIG. 4 is a flow chart of operation of the robot 10 in case of registering the status signal and the reaction signal. As an example, operation of the air conditioner 22 is explained.

First, assume that the robot 10 is under an initial status and does not have information of the air conditioner 22. The user operates the air conditioner 22 using a remote controller 21, and sets the heating as “ON” (S10). In this case, the air conditioner 22 acquires a control command from the remote controller 21, activates the heating, and outputs a status signal to the robot 10. The robot 10 acquires the status signal from the air conditioner 22 via UPnP (S20). In this case, the robot 10 does not have information of the air conditioner 22. Accordingly, the robot 10 can acquire the status signal but cannot understand a meaning of the status signal.

The robot 10 stores the status signal in the storage unit 15, and the expression unit 12 expresses the status signal (S30). For example, if the expression unit 12 is a speaker, the expression unit 12 outputs the status signal as speech. As mentioned-above, function of a home electric device is typically described by the designer's original rule, and speech output by the robot 10 is often not understandable for the user. However, the user already sets heating of the air conditioner to “ON”. Accordingly, the user knows that the speech from the robot 10 is the robot's expression originated from “ON” status of heating of the air conditioner 22. In this case, in response to the speech from the robot 10, the user replies “I turned on the heater” with voice. The reaction acquisition unit 13 acquires the user's voice “I turned on the heater” reacted within a predetermined period, and converts this voice to a reaction signal (S40). Next, the registration unit 14 relates the reaction signal to the status signal acquired at S20 (S50). Furthermore, the reaction signal and the status signal are relationally stored in the storage unit 15 (S60). In this way, registration of the status signal and the reaction signal is completed.

This registration operation is executed for various functions of the air conditioner 22. Furthermore, this registration operation is executed for another information home appliance 20. As a result, the robot 10 acquires status signals of various functions of many information home appliances 20 and reaction signals related to the status signals.

Furthermore, the reaction signal may be various languages (English, Japanese, French and so on). For example, when the user reacts in English, the robot 10 relationally registers a reaction signal as English and the status signal. Furthermore, the reaction signal may be a cryptograph understandable by the user only. In this way, the robot 10 can register the status signal by the user's original language, facial expression, or gesture.

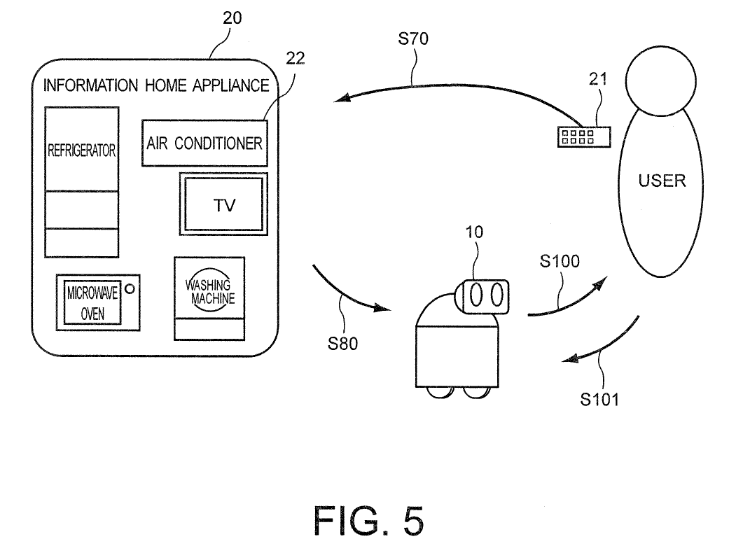

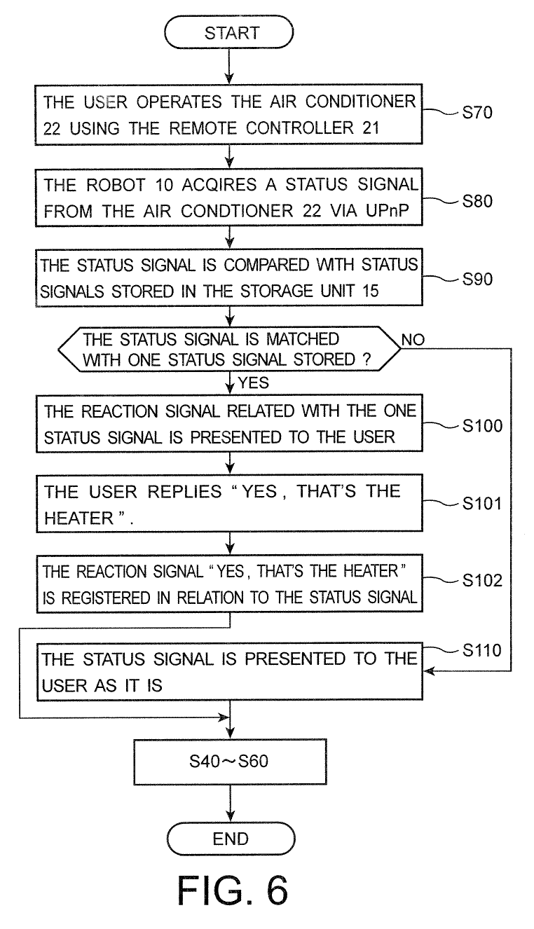

FIG. 5 is a schematic diagram of operation of the robot 10 in case of strengthening relationship between the status signal and the reaction signal. FIG. 6 is a flow chart of operation processing of the robot 10 in case of strengthening the relationship.

After completing above-mentioned registration, the user operates the air conditioner 22 using the remote controller 21 (S70). In this case, the air conditioner 22 operates based on a control command from the remote controller 21, and outputs a status signal to the robot 10. The robot 10 acquires the status signal from the air conditioner 22 via UPnP (S80). The storage unit 15 already stores the status signal and the reaction signal mutually related. Accordingly, the first comparison unit 16 compares a status signal acquired at S80 with the status signal stored in the storage unit 15 (S90). As a result, if these status signals are matched, the expression unit 14 presentably expresses the reaction signal related with the status signal stored in the storage unit 15 to the user (S100). For example, when the user sets heating of the air conditioner 22 to “ON” again, the status signal acquired at S80 is matched with the status signal stored in the storage unit 15. Accordingly, the expression unit 12 outputs the reaction signal related with the status signal. Concretely, the robot 10 outputs speech “I turned on the heating” from the speaker.

In this case, when the user replies “Yes, that's the heater” within a predetermined period (S101), the reaction acquisition unit 13 converts this reply to a reaction signal, and the registration unit 14 relationally registers the reaction signal and the status signal (S102). In this way, the reaction signal related with the status signal as “ON” status of the heater increases. Furthermore, in the user's reaction “I turned on the heater” and “Yes, that's the heater”, a phrase word “the heater” is overlapped. Accordingly, the robot 10 can strength a relationship (link) between the status signal and the phrase “the heater”.

If these status signals are not matched, the expression unit 14 outputs the status signal acquired at S80 as it is to the user (S110). In this case, processing of S40˜S60 is executed again. As a result, the status signal acquired at S80 and the reaction signal acquired from the user are relationally registered. For example, when the user sets heating of the air conditioner 22 to “OFF” status, the status signal acquired at S80 is not matched with the status signal stored in the storage unit 15. Accordingly, the robot 10 outputs the status signal acquired at S80, and acquires the user's reply “I turned off the heater” for the outputted status signal. Furthermore, the robot 10 relationally registers the status signal acquired at S80 and a reaction signal “I turned off the heater”.

In this way, the robot 10 can relate various status signals with various reaction signals, and relationally store these signals. Furthermore, by relating one status signal with a plurality of reaction signals, a relationship (link) between the status signal and the user's reaction can be strengthened.

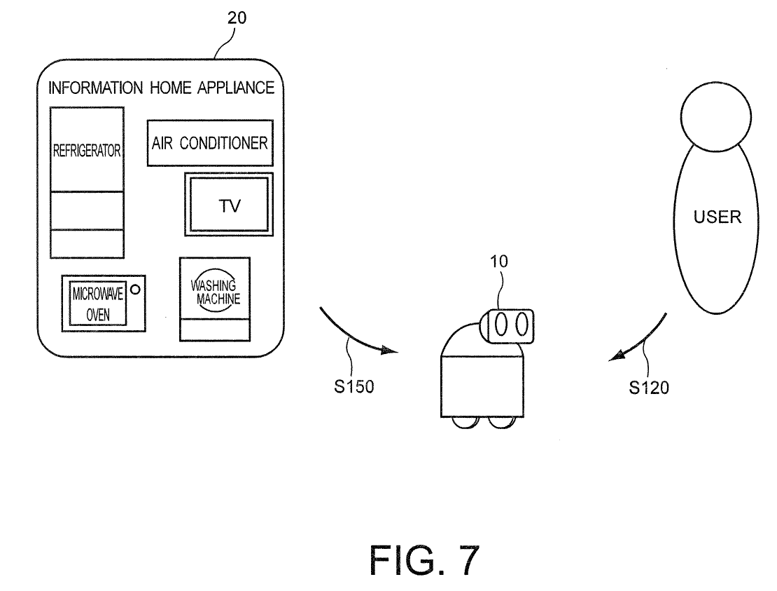

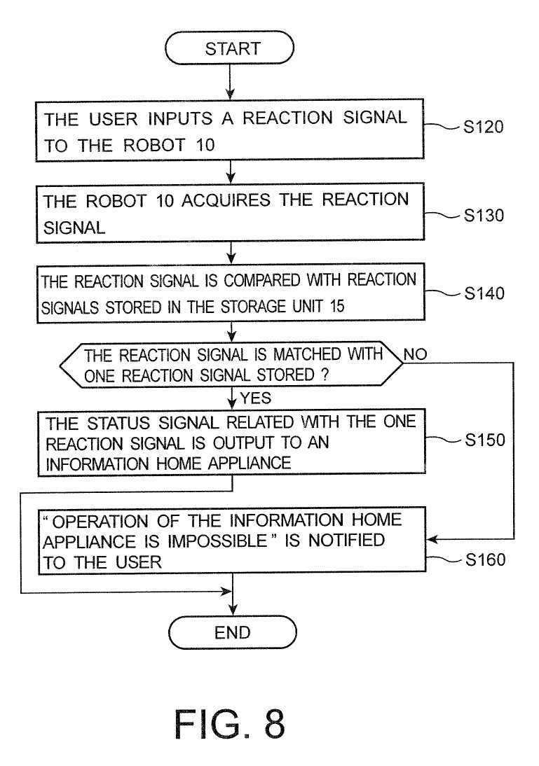

FIG. 7 is a schematic diagram of operation of the robot 10 in case of operating the information home appliance 20. FIG. 8 is a flow chart of operation processing of the robot 10 in case of operating the information home appliance 20.

By repeating registration and/or link-strengthening of the status signal and the reaction signal, the status signal and the reaction signal are stored in the storage unit 15 to some extent. In this case, the user inputs a reaction signal to the robot 10 without inputting a status signal to the information home appliance 20 (S120). For example, the user utters “Turn on the heater” only.

The reaction acquisition unit 13 acquires a reaction signal (S130). For example, the reaction acquisition unit 13 acquires speech “Turn on the heater”, and converts this speech to a reaction signal. Next, the second comparison unit 17 compares this reaction signal with the reaction signal stored in the storage unit 17 (S140). For example, the second comparison unit 17 retrieves the reaction signal “Turn on the heater” from the storage unit 15. In this case, it is not necessary that the reaction signal acquired by the reaction acquisition unit 13 is perfectly matched with the reaction signal stored in the storage unit 15. Briefly, these reaction signals may be partially matched. For example, if a word “heater” in “turn on the heater” is matched with a word “heater” in “I turned on the heater”, the second comparison unit 17 decides that these reaction signals match.

As a result, if these reaction signals match, the status signal related with this reaction signal is output to the information home appliance 20 (S150). In this case, if a word “heater” is strongly linked with this status signal, the expression unit 12 may repeatedly output speech “heater, heater” for confirmation. Next, the information home appliance 20 changes its operation status based on the status signal. For example, the air conditioner sets heating to “ON” status. In this way, the user can operate the information home appliance 20 by ordering with speech via the robot 10 as an interface.

If the reaction signal acquired by the reaction acquisition unit 13 does not match a reaction signal stored in the storage unit 15, the robot 10 may not operate. However, in order to notify the user of impossibility of operation of the information home appliance 20, the expression unit 12 may notify as “Operation of the information home appliance is impossible” (S160). This notification may be previously set in the robot 10.

In response to this notification, the user may execute registration and/or link-strengthening of the status signal and the reaction signal again.

In the first embodiment, the robot 10 is applied as an interface apparatus. However, the interface apparatus may be a fixed terminal.

In the first embodiment, the reaction signal is an electric signal converted from speech. However, the reaction signal may be a magnetic signal or an optical signal converted from speech.

In the first embodiment, the reaction acquisition unit 13 acquires the user's reply reaction within a predetermined period. However, the reaction acquisition unit 13 may continuously acquire the user's reaction until the user makes a predetermined sign. The predetermined sign may be the user's predetermined sound (For example, clapping of hands).

In the first embodiment, perfect matching between the reaction signal acquired by the reaction acquisition unit 13 and the reaction signal stored in the storage unit 15 is not required. Accordingly, the second comparison unit 17 may calculate a difference between these reaction signals as a similarity. For example, in case of speech signal, a similarity used for general speech recognition may be utilized. Otherwise, sound feature quantity such as a pitch or a pattern may be used. The second comparison unit 17 selects a status signal related to the reaction signal having the highest similarity. The robot 10 outputs the status signal to the information home appliance 20.

If this status signal is not the user's desired one, the user may notify the robot of this purport. For example, when the user orders “Turn on the heater” to the robot, assume that the robot 10 erroneously outputs a status signal to set a cooler “ON” to the air conditioner 22. In this case, the user informs “It is the cooler” to the robot 10. The robot 10 converts speech “It is the cooler” to a reaction signal, and relationally registers this reaction signal and a status signal to set the cooler as “ON” status. In this case, the robot 10 can learn.

In this way, in the first embodiment, by the user's natural interacting with the robot 10 using his/her original language, facial expressions or gestures, the robot 10 can learn. Furthermore, by ordering the robot 10 using the user's language, facial expression, or gesture, the information home appliance 20 can be easily operated.

In the first embodiment, the robot 10 need not prepare data (For example, a dictionary) of the information home appliance 20. Accordingly, the robot 10 can operate various information home appliances 20, and general use rises. Furthermore, such robot 10 is suitable for mass production and can be produced with low cost.

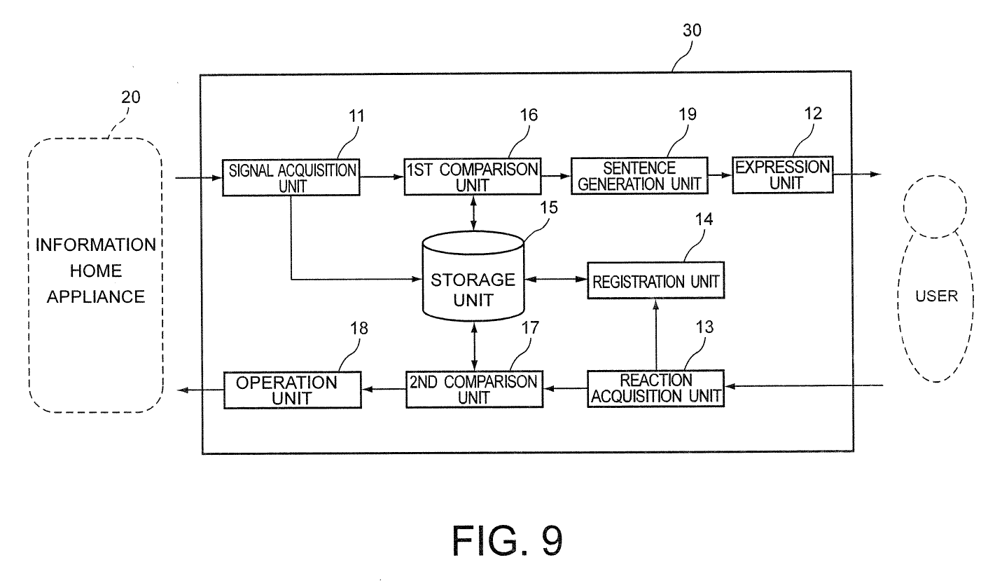

FIG. 9 is a block diagram of a robot 30 according to a second embodiment. In the second embodiment, the robot 30 has wheels, a wheel axis sensor measuring a moving direction and a moving distance of the wheel, a supersonic wave sensor detecting an obstacle near the robot 30, and map data of a movement region of the robot 30. The robot 30 can localize its own location and autonomously move to the indicated position by avoiding the obstacle. By moving to a set place of the information home appliance which outputted the status signal, the robot 30 can notify the user of the information home appliance corresponding to the status signal/the reaction signal. Alternatively, the robot 30 may output the status signal or the reaction signal while moving to the user's location. In this case, the user can easily listen or watch the robot's reaction signal.

Furthermore, the robot 30 relationally registers a sentence representing a status of the information home appliance 20 with each word. The robot 30 prepares a sentence creation unit 19 to combine a plurality of words. Accordingly, the robot 30 can apply a reaction signal for various status signals. In the second embodiment, a washing machine 23 is used as an example of the information home appliance 20.

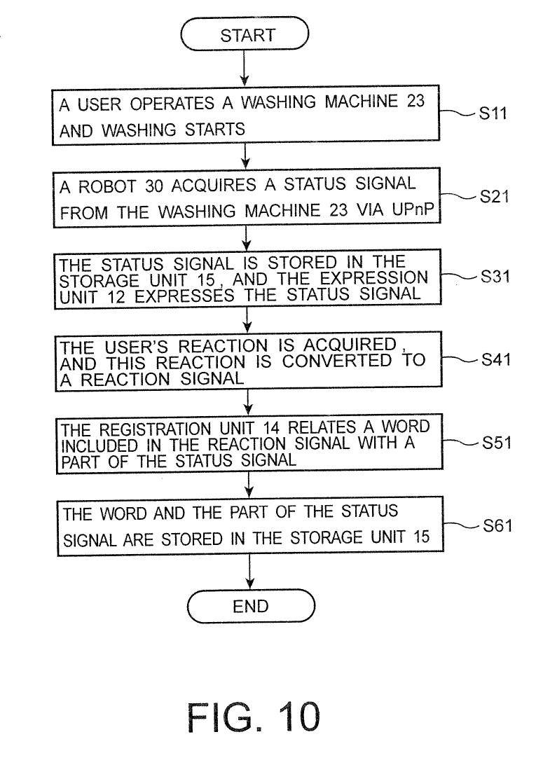

FIG. 10 is a flow chart of operation of the robot 30 in case of registering the status signal/the reaction signal. Concept figure representing relationship among the robot 30, the information home appliance 20, and the user is the same as FIGS. 1, 3, 5, and 7. Accordingly, its explanation is omitted.

First, assume that the robot 30 is under an initial status and does not have information of the washing machine 23. The user operates the washing machine 23 in order to start washing (S11). In this case, the washing machine 23 starts washing by the user's operation, and outputs a status signal to the robot 30. The robot 30 acquires the status signal from the washing machine 23 via UPnP (S21). However, the robot 30 does not have information of the washing machine 23. Briefly, the robot 30 can acquire the status signal but cannot understand the status signal.

In the robot 30, the status signal is stored in the storage unit 15, and the expression unit 12 presentably expresses the status signal (S31). As mentioned-above, a function of the home electric device is described by a designer's original rule. The user often cannot understand a speech outputted by the robot. However, the user is operating the washing machine 23 by himself/herself. Accordingly, the user understands the robot's speech as some expression originated from washing start. In this case, the user replies “I started washing” in response to the robot speech. In the robot 30, the reaction acquisition unit 13 acquires the user's reply “I started washing” reacted within a predetermined period, and converts this reply to a reaction signal (S41).

Next, the registration unit 14 relates a word included in the reaction signal with a part of the status signal acquired at S21 (S51). The status signal includes a kind and a status of the information home appliance 20. For example, the kind of the information home appliance 20 means “WASHING” and the status of the information home appliance 20 means “START”. Furthermore, the reaction signal represents a sentence including a plurality of words related with the kind and the status of the information home appliance. For example, the reaction signal “I started washing” includes a word “washing” related with a kind of the information home appliance and a word “start” related with a status of the information home appliance.

Accordingly, the registration unit 14 relationally registers each word included in the reaction signal and the kind and the status of the information home appliance. For example, the registration unit 14 relates “washing” of the reaction signal with “WASHING” of the status signal, and relates “start” of the reaction signal with “START” of the status signal.

Each word in the reaction signal and the related part in the status signal are stored in the storage unit 15 (S61). In this way, registration of the status signal and the reaction signal is completed.

In the same way as in the first embodiment, this registration operation is executed for various functions of the washing machine 23. Furthermore, the reaction signal may be represented by various languages (English, Japanese, French, and so on).

As mentioned-above, the status signal is described by the designer's original rule. In the second embodiment, for convenience' sake, the status signal is represented as English.

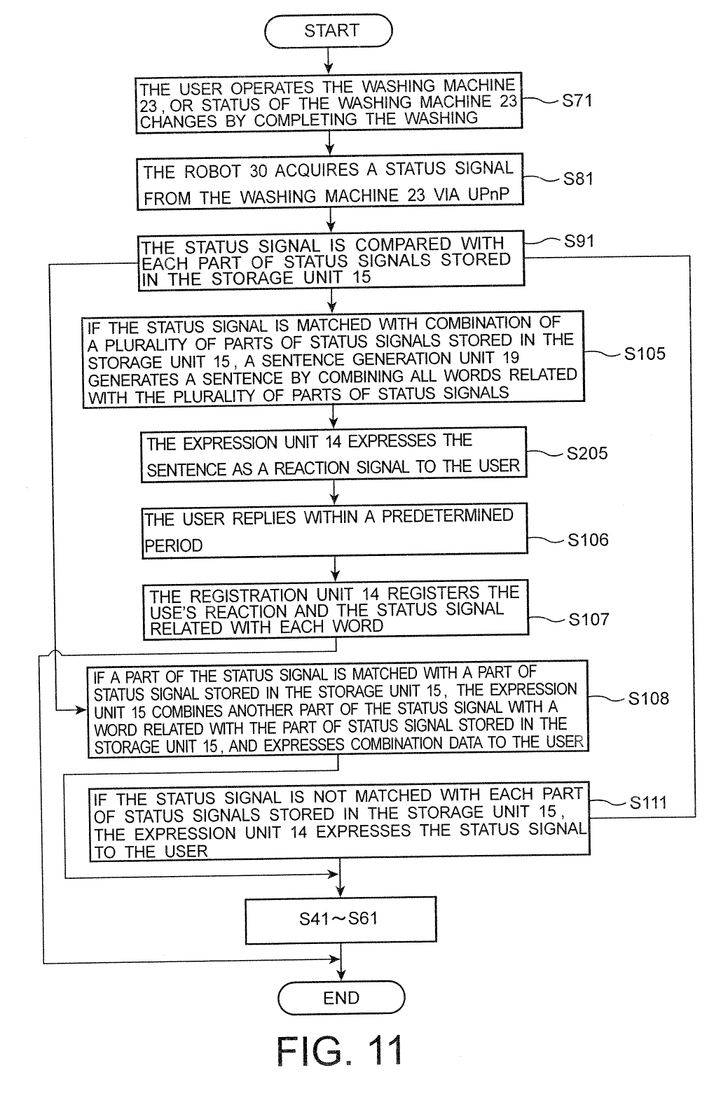

FIG. 11 is a flow chart of operation processing of the robot 30 in case of link-strengthening. After completion of the registration, the user operates the washing machine 23. Alternatively, by completing the washing, a status of the washing machine 23 changes (S71). Briefly, the washing machine 23 operates based on the user's input command, or the washing is completed. In this case, the washing machine 23 outputs a status signal to the robot 30. The robot 30 acquires the status signal from the washing machine 23 via UPnP (S81). As mentioned-above, the storage unit 15 already stores a part of the status signal and a word (related with the part) of the reaction signal. Accordingly, the first comparison unit 16 compares a status signal acquired at S81 with each part of the status signal stored in the storage unit 15 (S91).

As a result, if the status signal acquired at S81 is matched with a combination of parts of the status signal stored in the storage unit 15, the sentence generation unit 19 generates a sentence by combining words (of the reaction signal) related with the parts (S105). The expression unit 14 expresses the sentence as a reaction signal to the user (S205). For example, when the user operates the washing machine as washing start status, the status signal acquired at S81 is matched with two parts “WASHING” and “START” of the status signal stored in the storage unit 15. Accordingly, the sentence generation unit 19 generates a sentence by combining two words “washing” and “start” (of the reaction signal) related with the two parts. The expression unit 12 outputs this sentence as a reaction signal. Concretely, the robot 10 outputs speech “Washing starts” to the speaker.

In response to this speech, the user replies “Yes, washing started” within a predetermined period (S106). The reaction acquisition unit 13 converts this reply to a reaction signal, and the registration unit 14 relationally registers a word of this reaction signal and a part of the status signal (S107). As a result, a word related with a part “WASHING” of the status signal and a word related with a part “START” of the status signal respectively increase. Furthermore, in the reaction signal “Washing starts.” and “Yes, washing started.”, a word “washing” overlaps. Accordingly, the robot 30 strengths a relationship (link) between the part “WASHING” of the status signal and the word “washing” of the reaction signal.

If a part of the status signal acquired at S81 is matched with a part of the status signal stored in the storage unit 15, the expression unit 14 combines another part of the status signal acquired at S81 and a word (of the reaction signal) related with the matched part of the status signal (stored in the storage unit 15), and expresses the combined sentence to the user (S108) For example, in the status signal acquired at S81 at completion timing of washing, “WASHING” is matched with a part “WASHING” of the status signal stored in the storage unit 15, but “FINISH” is not matched with a part “START” of the status signal stored in the storage unit 15. Accordingly, in the robot 30, the expression unit 12 generates a sentence by combining a word “washing” (of the reaction signal) related with a part “WASHING” of the status signal (stored in the storage unit 15) and unmatched part “FINISH” of the status signal (acquired at S81), and outputs the sentence. As mentioned-above, even if the status signal is output by speech, the user cannot understand the meaning. Accordingly, the robot 30 outputs speech “Washing ***” from the speaker. In this case, “***” represents a voice form of the status signal “FINISH”.

Next, processing of S41˜S61 in FIG. 10 is executed again. As a result, the unmatched part of the status signal acquired at S81 and a word of a reaction signal newly acquired from the user can be relationally registered. For example, the user replies “Washing finishes”. The second comparison unit 17 decides that a word “washing” in the reaction signal is already registered. Furthermore, the second comparison unit 17 decides that a word “finish” in the reaction signal corresponds to the unmatched part “FINISH” of the status signal acquired at S81. Accordingly, the registration unit 14 relationally registers the word “finish” in the reaction signal and the part “FINISH” of the status signal acquired at S81.

If the status signal acquired at S81 is not matched with each part of all status signals stored in the storage unit 15, the expression unit 14 expresses the status signal (acquired at S81) as it is to the user (S111). After that, processing S41˜S61 in FIG. 10 is executed again. As a result, a part of the status signal acquired at S81 and a word of a reaction signal newly acquired from the user can be relationally registered.

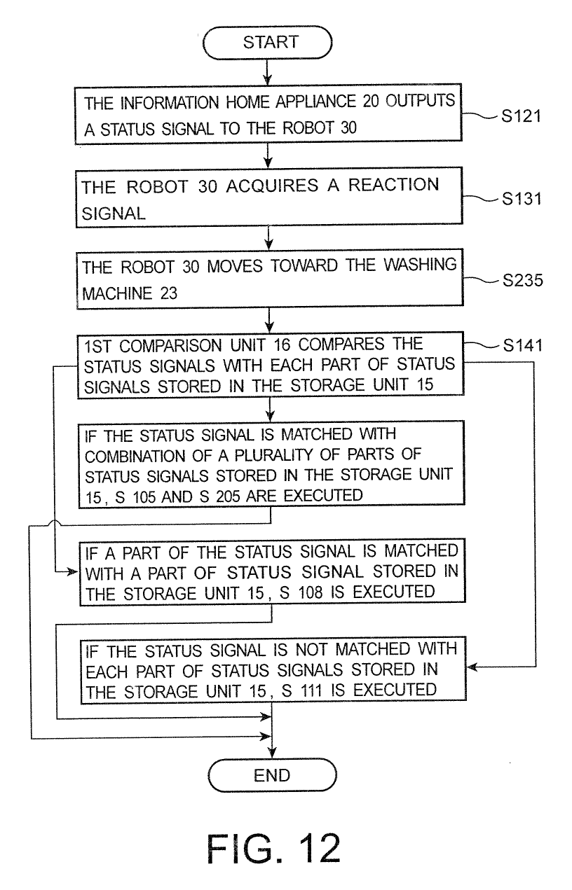

FIG. 12 is a flow chart of operation processing of the robot 30 in case of changing an operation status of the information home appliance 20. First, when the operation status of the information home appliance 20 changes, the information home appliance 20 outputs a status signal to the robot 30 (S121). For example, assume that the washing machine 23 completes washing. In this case, the washing machine 23 outputs a status signal meaning “WASHING FINISH”.

The robot 30 acquires the status signal via UPnP (S131), and moves toward the washing machine 23 (S235). Next, the first comparison unit 16 compares this status signal with each part of the status signal stored in the storage unit 15 (S141). For example, the first comparison unit 16 retrieves a part “WASHING” of the status signal and a part “FINISH” of the status signal from the storage unit 15.

As a result, if the status signal acquired at S131 is matched with a combination of parts of the status signal stored in the storage unit 15, processing of S105 and S205 in FIG. 11 is executed.

If a part of the status signal acquired at S131 is matched with a part of the status signal stored in the storage unit 15, processing of S108 in FIG. 11 is executed. If the status signal acquired at S131 does not match any part of the status signals stored in the storage unit 15, processing of S111 in FIG. 11 is executed. The processing S205, S108 and S111 are desired to be executed after the robot 30 reaches a location near the washing machine 23.

In the second embodiment, the robot 30 registers a sentence representing a status of the information home appliance 20 by relating each word. Furthermore, the robot 30 prepares the sentence generation unit 19 by combining a plurality of words. Accordingly, the robot 30 can apply the reaction signal to various status signals.

Furthermore, by moving to a location of the information home appliance which outputted the status signal, the robot 30 can notify the user of the information home appliance corresponding to the status signal/the reaction signal. In addition to this, the second embodiment has the effect of the first embodiment.

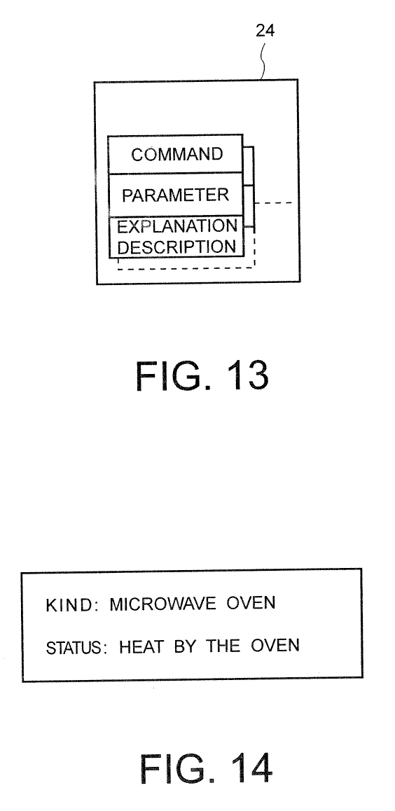

Next, a third embodiment is explained. In the third embodiment, in case of registering the status signal and the reaction signal, the robot 10 acquires an explanation description related with the status signal. FIG. 13 is a schematic diagram of the explanation description of a microwave oven 24 as the information home appliance. FIG. 14 is a schematic diagram of contents of the explanation description.

In FIG. 13, a command is an instruction including a status signal. A parameter is a set value or a status accompanied with the instruction. The explanation description is previously stored in the microwave oven 24 by accompanying with each command. As shown in FIG. 14, the explanation description represents a kind and a status of the information home appliance. The explanation description corresponds to “Device Description” or “Service Description” in UPnP. “Device Description” is an explanation description of each information home appliance. “Service Description” is an explanation description of each function (service) of the information home appliance. In FIG. 14, the kind of the information home appliance is “microwave oven” and the status of the information home appliance is “heat by the oven”. This explanation description is previously related with the status signal. Component of the robot 10 is the same as in the first embodiment.

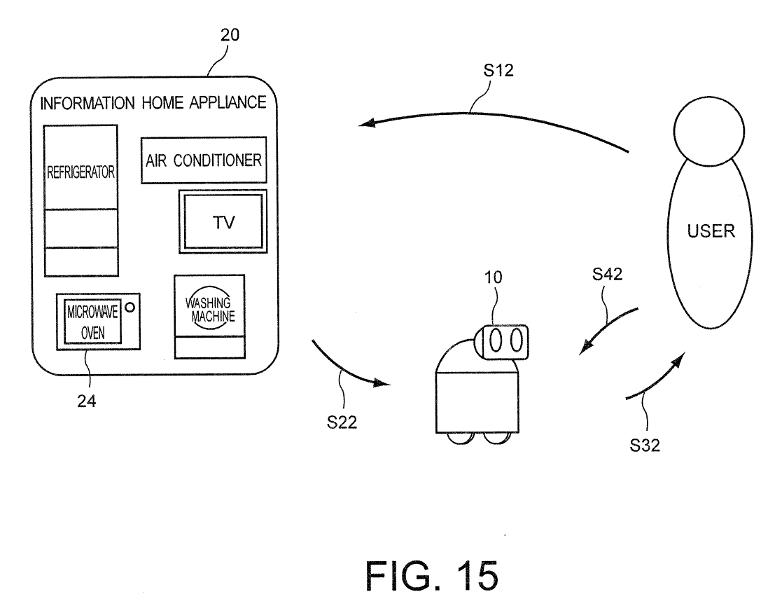

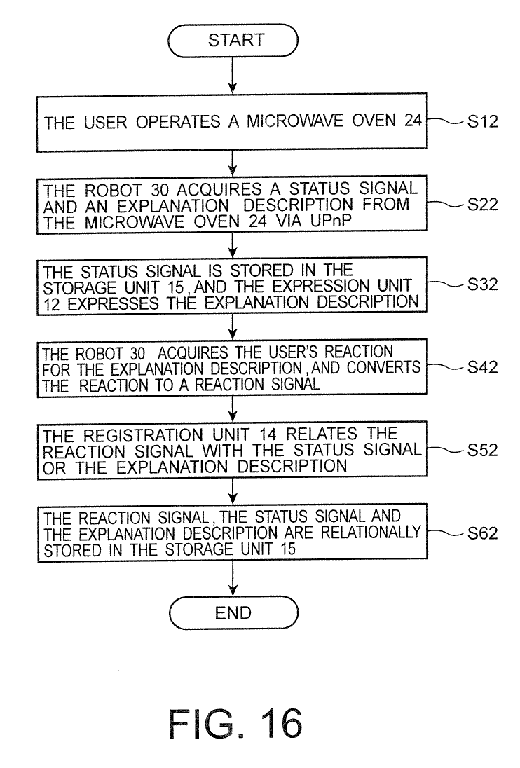

FIG. 15 is a schematic diagram of the robot's operation in case of registering the status signal, the explanation description, and the reaction signal. FIG. 16 is a flow chart of operation processing of the robot 10 in case of registering the status signal, the explanation description, and the reaction signal. First, assume that the robot 10 is under an initial status and does not have information of the microwave oven 24. The user operates the microwave oven 24 and activates this oven (S12). In this case, the microwave oven 24 outputs a status signal and an explanation description related to the status signal. The robot 10 acquires the status signal and the explanation description from the microwave oven 24 via UPnP (S22). As mentioned-above, the robot 10 does not have information of the microwave oven 24. Accordingly, the robot 10 can acquire the status signal but cannot understand the meaning of the status signal.

In the robot 10, the status signal and the explanation description are stored in the storage unit 15, and the expression unit 12 presentably expresses the explanation description (S32). For example, if the expression unit 12 is a speaker, the expression unit 12 outputs the explanation description as speech. For example, the expression unit 12 expresses “heat by the oven”. As shown in FIG. 14, the explanation description is represented by the user's understandable language. In this case, the user can understand a status of the microwave oven 24 by the speech outputted from the robot 10. However, this speech is different from the users. Accordingly, in response to the robot's speech, the user replies with voice as “I turned on the oven”. In the robot 10, the reaction acquisition unit 13 acquires the user's reply “I turned on the oven” within a predetermined period, and converts the reply to a reaction signal (S42). Next, the registration unit 14 relates the reaction signal with the status signal and the explanation description acquired at S22 (S52). Furthermore, the reaction signal, the status signal and the explanation description are relationally stored in the storage unit (S62). In this way, registration of the status signal, the explanation description, and the reaction signal is completed.

Link-strengthening among the status signal, the explanation description, and the reaction signal is almost the same as in the first embodiment. However, after S90, in case of not matching the status signal, the robot 10 presentably expresses the explanation description instead of the status signal at S110.

The robot's operation processing in response to the user's operation is the same as in the first embodiment. The third embodiment has the same effect as the first embodiment. Furthermore, in the third embodiment, the information home appliance 20 previously stores the explanation description related with the status signal. Briefly, the robot 10 expresses the explanation description without expressing the status signal. Accordingly, the user can easily register the reaction signal. As a result, the user can easily teach the robot 10.

Next, a fourth embodiment is explained. A interface system of the fourth embodiment includes the robot 10 and the information home appliance 20 as shown in FIG. 1. Components of the robot 10 are the same as components in FIG. 2. A function (status signal) of the information home appliance 20 is disclosed by UPnP, and the robot 10 acquires the status signal via UPnP. Briefly, the information home appliance 10 may be a UPnP device, and the robot 10 may be a UPnP control point (UPnP-CP).

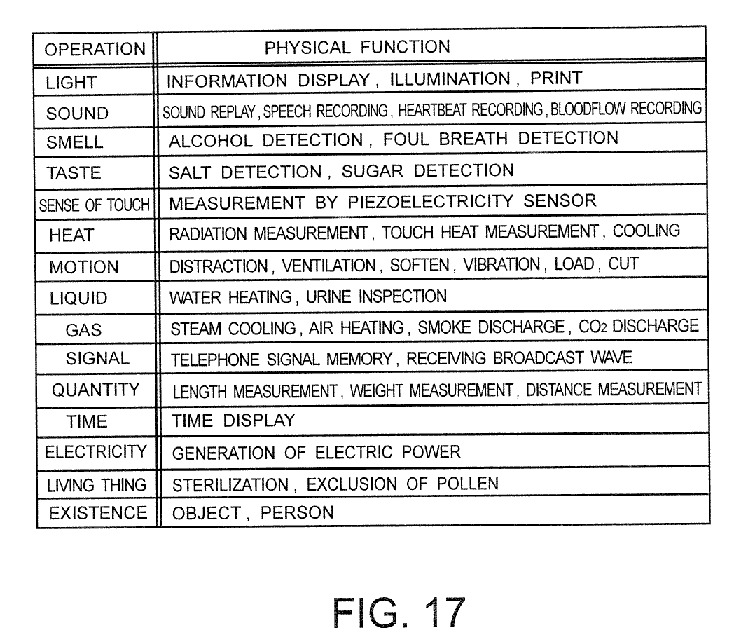

The robot 10 stores a classification list in the storage unit 15 as shown in FIG. 17. In the classification list of FIG. 17, function loaded onto the home electric appliance is classified into two categories. The first category is an operation of physical unit related with a person and an environment. For example, “light, sound, smell, taste, sense of touch, heat” related with human's five senses, “liquid, gas, motion, living thing, existence” related with the environment, and “electricity, quantity, time” are stored. The second category is a physical function of the first category. For example, as for “light” of the first category, “information display, illumination and print” are stored. The first category and the second category are mutually related. For example, the first category “light” is related to the second category “information display, illumination, print”. The first category “sound” is related to the second category “sound replay, speech recording, heartbeat recording, bloodflow recording”. This classification list is previously stored in the robot 10, or created by the robot 10 based on information acquired from the information home appliance 20.

The information home appliance 20 represents each function loaded onto its own appliance as above-mentioned classification and stores as explanation description. For example, a television has “a monitor and a speaker”. As for the monitor, “the first category (light) and the second category (information display)” are stored. As for the speaker, “the first category (sound)” and the second category (sound replay)” are stored.

The information home appliance 20 stores kind data representing a kind of its own appliance, a related status signal, and an explanation description related with the kind. For example, the kind data may be a kind such as an air conditioner or a television of the information home appliance 20. Furthermore, the kind data may be a kind of a part in the information home appliance 20, such as a thermometer, a heater or a sterilizer of the air conditioner, a screen or a speaker of the television. The status signal and the explanation description are the same as in the third embodiment.

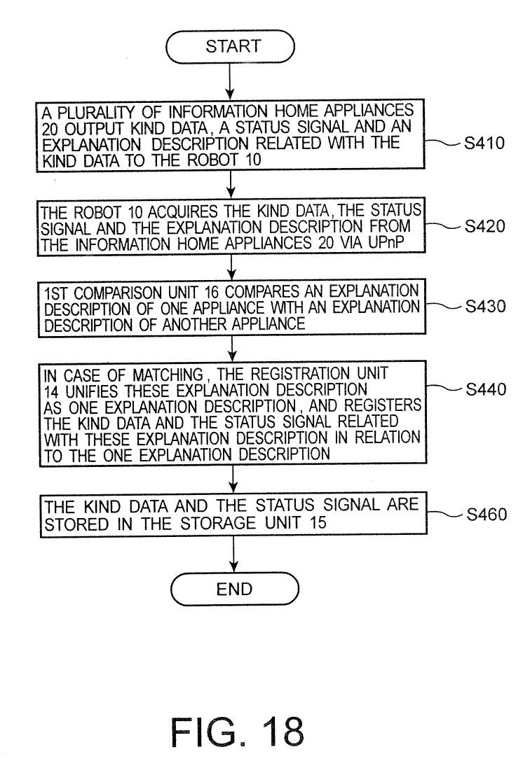

Hereinafter, operation of the interface system of the fourth embodiment is explained. FIG. 18 is a flow chart of operation of the robot 10 in case of registering the kind data, the status signal, and the explanation description.

First, a plurality of information home appliances 20 previously outputs a kind signal, a status signal, and an explanation description to the robot 10 (S410). The robot 10 acquires the kind signal, the status signal, and the explanation description via UPnP (S420).

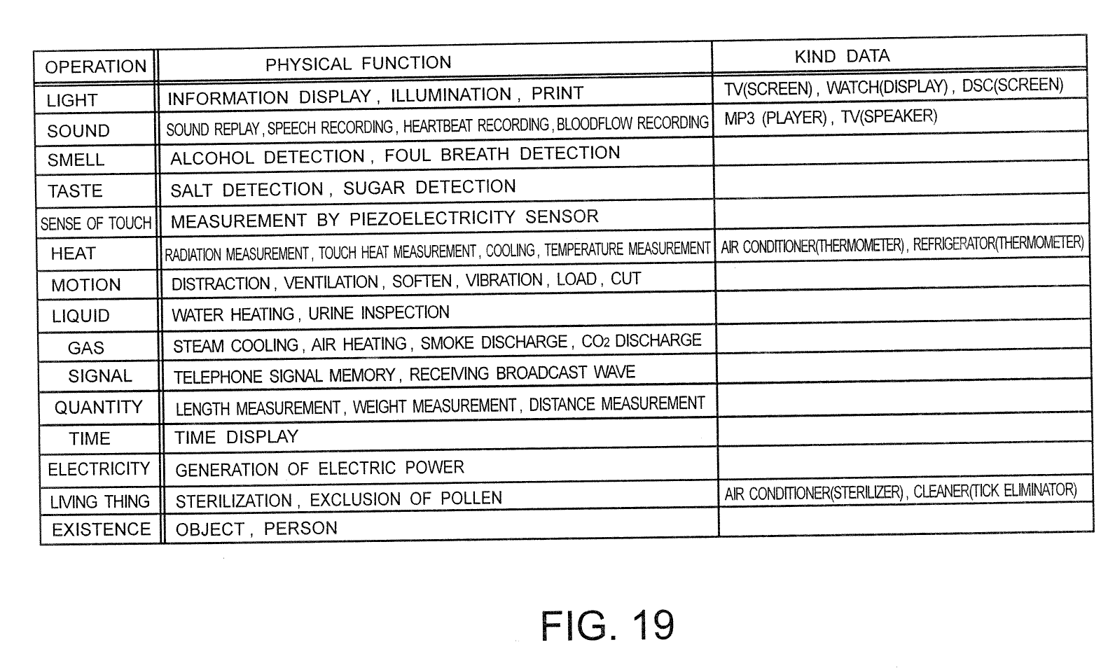

Next, the first comparison unit 16 compares an explanation description of one information home appliance 20 with an explanation description of another information home appliance 20 (S430). If these explanation descriptions match, the registration unit 14 unifies these explanation descriptions as one explanation description, and relationally registers a plurality of kind data and status signals related with these explanation descriptions and the one explanation description (S440). For example, assume that the robot 10 acquires an explanation description “temperature measurement” related with kind data “air conditioner (thermometer)”, an explanation description “temperature measurement” related with kind data “refrigerator (thermometer)”, and a status signal as a measurement signal of temperature. In this case, two explanation descriptions “temperature measurement” match. Accordingly, the registration unit 14 relationally registers two kind data “air conditioner (thermometer)” and “refrigerator (thermometer)” with the status signal “temperature measurement”. The kind data and the explanation description registered by the registration unit 14 are stored in the storage unit 15 (S460). As shown in FIG. 19, in an operation “heat” of the classification list, kind data “air conditioner (thermometer)” and “refrigerator (thermometer)” are relationally stored with the explanation description (physical function) “temperature measurement”.

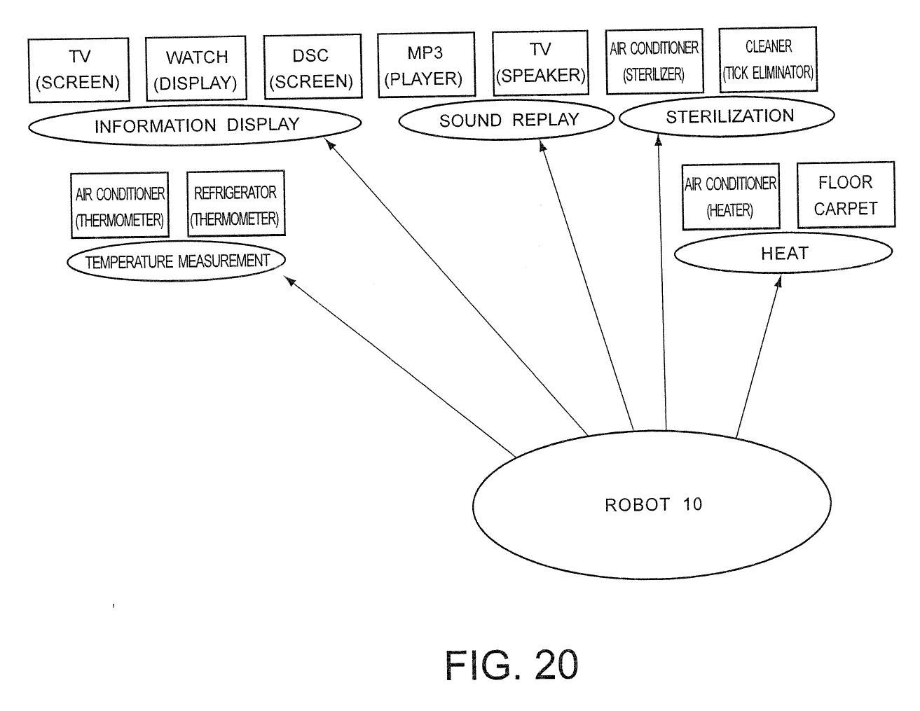

FIG. 20 is a schematic diagram of relationships among the explanation description (physical function), the kind data, and the robot 10. For example, as for the explanation description “information display”, three kind data “TV (screen)”, “watch (display)” and “DSC (screen)” are related. As for the explanation description “temperature measurement”, two kind data “air conditioner (thermometer)” and “air conditioner (thermometer)” are related. In this way, the storage unit 15 stores the kind data by each explanation description according to the classification.

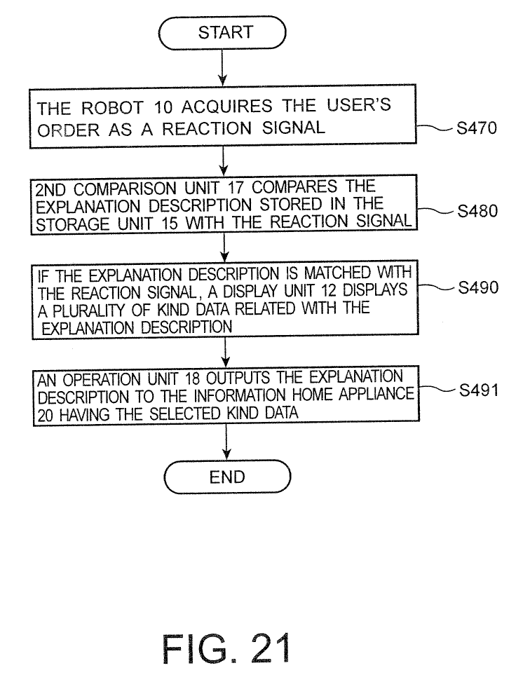

FIG. 21 is a flow chart of processing of the interface system in case of operation. First, a user orders a desired function to the robot 10. In this case, the user is an operator of the interface apparatus or an application program in the interface apparatus. In the robot 10, the reaction acquisition unit 13 acquires the user's order (instruction) as a reaction signal (S470). Next, the second comparison unit 17 compares the reaction signal acquired by the reaction acquisition unit 13 with each explanation description stored in the storage unit 15 (S480). If the reaction signal matches one explanation description, the display unit 12 displays a plurality of kind data related with the one explanation description (S490). For example, if the user's order (reaction signal) is “I want to know the temperature.”, the display unit 12 displays two kind data “air conditioner (thermometer)” and “refrigerator (thermometer)” related with the explanation description “temperature measurement”.

When the user selects one of the kind data displayed, the operation unit 18 outputs the explanation description (status signal) to an information home appliance 20 having the kind data selected (S491). The information home appliance 20 operates based on this explanation description. For example, when a user wants to know a room temperature (not a temperature of the refrigerator), the user selects “air conditioner (thermometer)”. The operation unit 18 outputs a status signal corresponding to the explanation description “temperature measurement” to the air conditioner. The air conditioner measures a room temperature using a thermometer, and replies the room temperature to the robot 10. The robot 10 displays the room temperature through the display unit 12. In this way, the user can know the room temperature.

As mentioned-above, in the fourth embodiment, the robot 10 stores the kind data of the information home appliance 20 in correspondence with each physical function (explanation description) of the information home appliance 20. Accordingly, the user need not know functions of each information home appliance 20. Furthermore, by ordering a desired function, the user can know the information home appliance 20 having the function from the robot 10.

The fourth embodiment may be combined with the second embodiment. In this case, the robot 10 inputs the acquired explanation description to the sentence generation unit 19 (in FIG. 9), and displays the generated sentence to the user by the sentence generation unit 19.

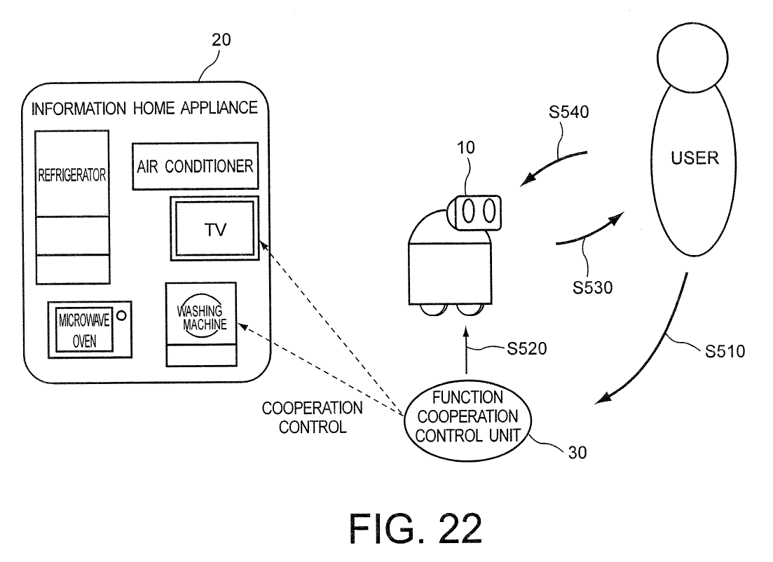

Next, a fifth embodiment of the present invention is explained. FIG. 22 is a schematic diagram of relationships among the interface apparatus (robot) 10, the information home appliance 20, a function cooperation control unit 30, and the user.

The function cooperation control unit 30 previously stores an explanation description of the information home appliance 20, a status signal, and a cooperation status signal of the information home appliance 20. The explanation description represents an operation status based on the status signal of the information home appliance 20, which is related to the status signal. One cooperation status signal is related to a plurality of explanation descriptions of information home appliances 20.

As an example of the function cooperation control unit 30, the client described in Japanese Patent Disclosure (Kokai) No. 2004-320747 is known. Components of the robot 10 and the information home appliance 20 are the same as in the first embodiment.

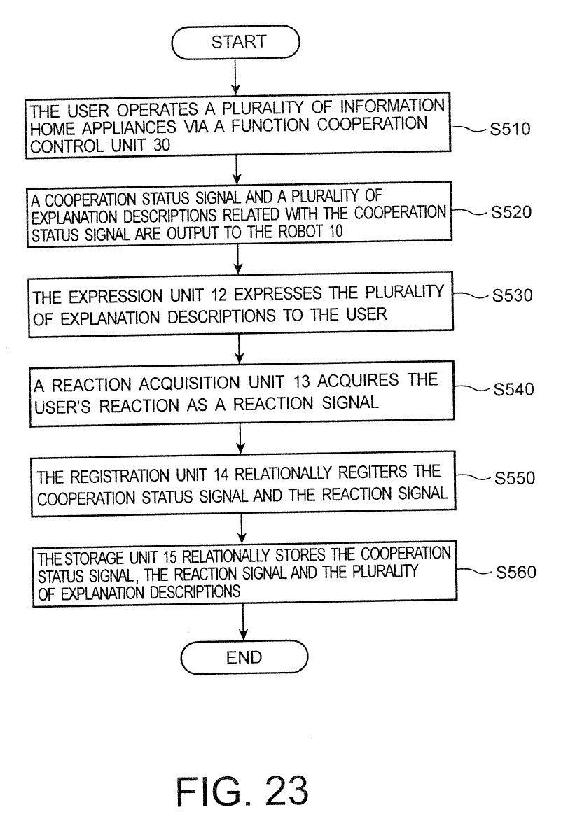

FIG. 23 is a flow chart of processing of the robot 10 in case of registering the cooperation status signal, the explanation description and the reaction signal. First, the user operates a plurality of information home appliances using the function cooperation control unit 30 (S510). In this case, the function cooperation control unit 30 outputs a status signal to the plurality of information home appliances, and outputs a cooperation status signal and a plurality of explanation descriptions related to the status signal to the robot 10 (S520). This explanation description is an explanation related to the status signal outputted to the plurality of information home appliances. The robot 10 acquires the cooperation status signal and the plurality of explanation descriptions related to the cooperation status signal. For example, assume that a first explanation description “superimpose on a screen” and a second explanation description “(image as a scene of the laundry being taken out)” are related with a cooperation status signal “XXX”. In this case, the cooperation status signal is described by an original rule of the designer who designed cooperation function of home appliances. Accordingly, in general, the interface apparatus cannot understand the cooperation status signal (For example, XXX).

Next, in the robot 10, the expression unit 12 presentably expresses the plurality of explanation descriptions to the user (S530). The user reacts (replies) in response to a notification from the expression unit 12. The reaction acquisition unit 13 acquires the user's reply as a reaction signal (S540). For example, the expression unit 12 outputs the first explanation description “superimpose on a screen” by speech while displaying the second explanation description as an image “a scene of the laundry being taken out” on a screen of the television. In response to this expression, the user utters “Completion notification of washing”) to the robot 10.The reaction acquisition unit 13 directly acquires the user's speech as a reaction signal or acquires the processing result of the user's speech as a reaction signal.

Next, in the robot 10, the registration unit 14 relationally registers the cooperation status signal and the reaction signal (S550). The storage unit 15 relationally stores the cooperation status signal, the reaction signal, and the plurality of explanation descriptions (S560).

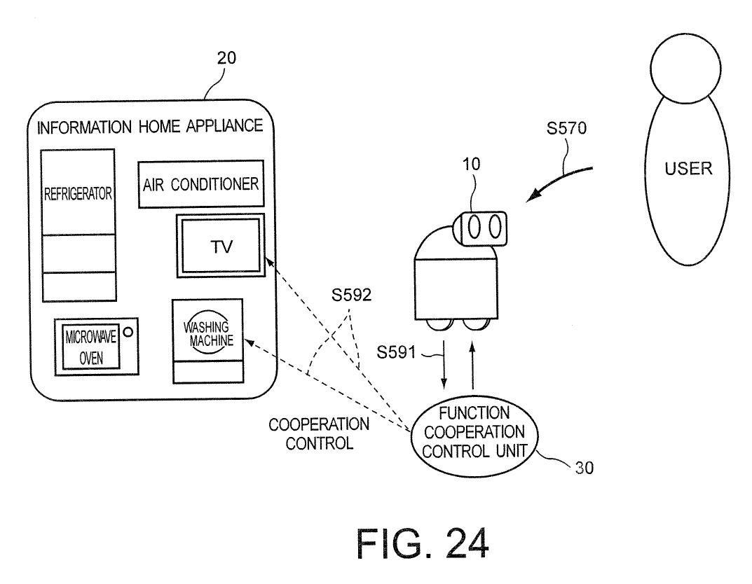

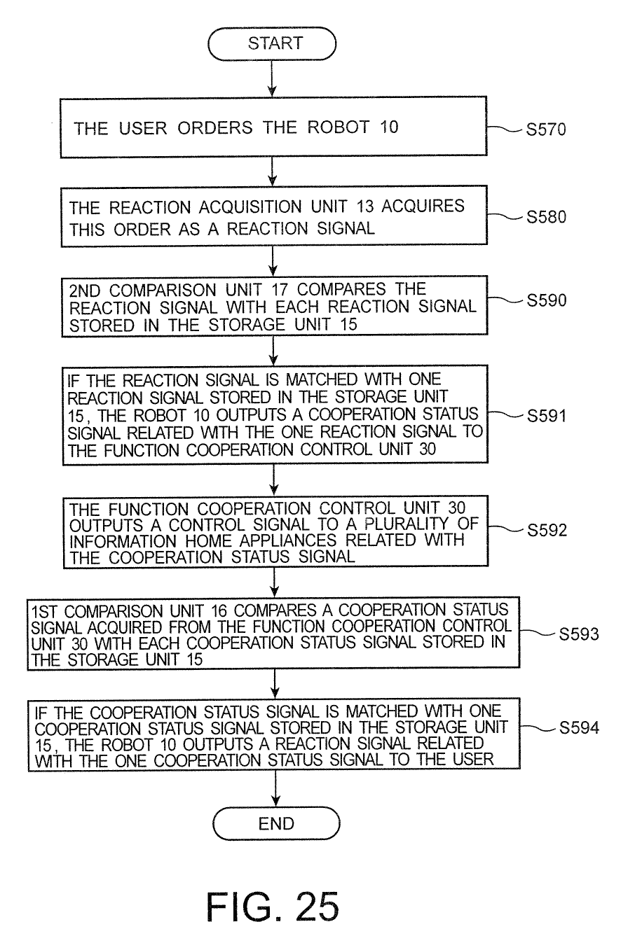

FIG. 24 is a schematic diagram of relationships among the robot 10, the information home appliance 20, the function cooperation control unit 30, and the user in case of operation. FIG. 25 is a flow chart of processing of the robot 10 in case of operation.

First, the user orders the robot 10 (S570). In the robot 10, the reaction acquisition unit 13 acquires this order as a reaction signal (S580). The second comparison unit compares the reaction signal acquired by the reaction acquisition unit 13 to each reaction signal stored in the storage unit 15 (S590). If any reaction signals match, the robot 10 outputs a cooperation status signal related to the reaction signal to the function cooperation control unit 30 (S591). The function cooperation control unit 30 outputs a control signal to a plurality of information home appliances related with the cooperation status signal (S592). For example, if the reaction signal is “Completion notification of washing”, the robot 10 outputs the cooperation status signal “XXX” to the function cooperation control unit 30. The function cooperation control unit 30 outputs a control signal meaning “superimpose on a screen” to the television and outputs a control signal meaning “completion notification of washing” to the washing machine.

Next, in the robot 10, the first comparison unit 16 compares a cooperation status signal newly acquired by the function cooperation control unit 30 with the cooperation status signal stored in the storage unit 15 (S593). For example, after completing washing, the washing machine outputs a status signal meaning “completion of washing” to the function cooperation control unit 30. The function cooperation control unit 30 displays an image “a scene of the laundry being taken out” and characters “The washing is completed.”, and outputs a cooperation status signal “XXX” to the robot 10. In the robot 10, this cooperation status signal “XXX” is compared with each status signal stored in the storage unit 15. The cooperation status signal “XXX” is already related to a reaction signal “completion notification of washing” in the storage unit 15. Accordingly, the robot 10 outputs the reaction signal “completion notification of washing” by speech to the user (S594). In this way, the user can notice “the image of the laundry being taken out” displayed on the television.

As mentioned-above, in the fifth embodiment, the user can control the function cooperation control unit 30 via the robot 10. The robot 10 need not understand the meaning of a function of each information home appliance, and need not understand the meaning of a service combined by a plurality of information home appliances. Accordingly, the designer can independently design the information home appliance 20 and the robot 10.

The fifth embodiment may be combined with the second embodiment. In this case, in the robot 10, an explanation description acquired is input to the sentence generation unit 19 (in FIG. 9) and the sentence generated by the sentence generation unit 19 can be displayed to the user. Furthermore, in FIGS. 22 and 24, the function cooperation control unit 30 is shown as a different unit from the robot 10. However, the function cooperation unit 30 may be included in the robot 10. In this case, all components of the interface system of the fifth embodiment can be simplified.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An interface apparatus for communicating with a home appliance, comprising:
a signal acquisition unit configured to acquire a status signal representing an operation status of the home appliance;
an expression unit configured to presentably express the status signal to the user by the user's recognizable method;
a reaction acquisition unit configured to acquire a reaction signal by converting the user's reaction in response to the status signal expressed;
a registration unit configured to register relativity in the status signal and the reaction signal;
a storage unit configured to store the status signal and the reaction signal with the relativity; and
a first comparison unit configured to compare an acquired status signal by said signal acquisition unit to the stored status signal in said storage unit;
wherein, if the acquired status signal matches the stored status signal, said expression unit presentably expresses the reaction signal related to the stored status signal to the user, and
wherein, if the acquired status signal does not match the stored status signal, said expression unit presentably expresses the acquired status signal to the user, and said registration unit registers relativity in the acquired status signal and a reaction signal from the user in response to the acquired status signal expressed.

2. The interface apparatus according to claim 1, further comprising:
a second comparison unit configured to compare another reaction signal to the reaction signal stored in said storage unit when said reaction acquisition unit acquires the another reaction signal from the user, and
an operation unit configured to output the status signal to the home appliance if the another reaction signal matches the reaction signal.

3. The interface apparatus according to claim 2, wherein,
if the status signal includes a kind and a status of the home appliance and the reaction signal includes a plurality of words related to the kind and the status,
said registration unit registers relativity in the kind and the status and each word related to the kind and the status, and
said first comparison unit respectively compares a kind and a status of the home appliance in the acquired status signal to the kind and the status stored in said storage unit.

4. The interface apparatus according to claim 3, further comprising:
a sentence generation unit configured to generate a sentence by combining each word related to the kind and the status when a kind and a status in the acquired status signal respectively match the kind and the status stored in said storage unit.

5. The interface apparatus according to claim 1,
wherein the reaction signal is a signal converted from at least one of speech, an image, and a gesture.

6. The interface apparatus according to claim 1, further comprising:
a plurality of wheels;
a wheel axis encoder measuring a moving distance and a moving direction of a wheel;
a supersonic wave sensor detecting an obstacle near said interface apparatus; and
map data of a movement region of said interface apparatus.

7. The interface apparatus according to claim 6,
wherein said interface apparatus moves to a location of the home appliance or the user by using the plurality of wheels, the wheel axis encoder, the supersonic wave sensor, and the map data.

8. The interface apparatus according to claim 2, wherein,
when the home appliance outputs an explanation description representing operation contents related to the status signal,
said signal acquisition unit acquires the explanation description with the status signal,
said expression unit presentably expresses the explanation description to the user, and
said registration unit registers relativity in the status signal, the explanation description, and a reaction signal from the user in response to the explanation description expressed.

9. The interface apparatus according to claim 8, wherein,
when said signal acquisition unit acquires another explanation description with the acquired status signal,
said first comparison unit compares the acquired status signal to the stored status signal.

10. The interface apparatus according to claim 9, wherein,
if the acquired status signal does not match the stored status signal,
said expression unit presentably expresses the another explanation description to the user, and
said registration unit registers relativity in the acquired status signal, the another explanation description, and a reaction signal from the user in response to the another explanation description expressed.

11. The interface apparatus according to claim 8, wherein,
when a plurality of home appliances respectively output kind data of the home appliance with the status signal and the explanation description,
said signal acquisition unit acquires the kind data, the explanation description and the status signal from the plurality of home appliances.

12. The interface apparatus according to claim 11, wherein
said first comparison unit compares an explanation description from a first home appliance to another explanation description from a second home appliance, and
if the explanation description matches the another explanation description, said registration unit unifies the explanation description and the another explanation description as one explanation description, and registers relativity in the one explanation description, the kind data and the status signal of the first home appliance, and the kind data and the status signal of the second home appliance.

13. The interface apparatus according to claim 12, wherein,
when said reaction acquisition unit acquires a reaction signal from the user,
said second comparison unit compares the reaction signal to the one explanation description stored in said storage unit, and
if the reaction signal matches the one explanation description,
said expression unit displays a plurality of kind data related to the one explanation description stored in said storage unit.

14. The interface apparatus according to claim 13, wherein,
when one of the plurality of kind data is selected by the user,
said operation unit outputs the status signal related to one kind data selected in said storage unit to a home appliance which outputted the one kind data.

15. The interface apparatus according to claim 8, further comprising:
a function cooperation control unit configured to previously store a cooperation status signal of a plurality of home appliances and a plurality of explanation descriptions for the plurality of home appliances.

16. The interface apparatus according to claim 15, wherein,
when said function cooperation control unit outputs the cooperation status signal and the plurality of explanation descriptions,
said signal acquisition unit acquires the cooperation status signal and the plurality of explanation descriptions,
said expression unit presentably expresses the plurality of explanation descriptions to the user, and
said registration unit registers relativity in the cooperation signal, the plurality of explanation descriptions, and a reaction signal from the user in response to the plurality of explanation descriptions expressed.

17. The interface apparatus according to claim 16, wherein,
when said reaction acquisition unit acquires another reaction signal from the user,
said second comparison unit compares the another reaction signal to the reaction signal stored in said storage unit, and
if the another reaction signal matches the reaction signal stored in said storage unit,
said operation unit outputs the cooperation status signal related to the reaction signal stored in said storage unit to the plurality of home appliances via said function cooperation control unit.

18. The interface apparatus according to claim 16, wherein,
when said signal acquisition unit acquires another cooperation status signal from said function cooperation control unit,
said first comparison unit compares the another cooperation status signal to the cooperation status signal stored in said storage unit, and
if the another cooperation status signal matches the cooperation status signal stored in said storage unit,
said expression unit presentably expresses the reaction signal related to the cooperation status signal stored in said storage unit to the user.

19. A method for communicating with a home appliance, comprising:
acquiring a status signal representing an operation status of the home appliance;
presentably expressing the status signal to the user by the user's recognizable method;
acquiring a reaction signal by converting the user's reaction in response to the status signal expressed;
registering relativity in the status signal and the reaction signal;
storing the status signal and the reaction signal with the relativity in a memory;
comparing an acquired status signal to the stored status signal in the memory;
presentably expressing the reaction signal related to the stored status signal to the user if the acquired status signal matches the stored status signal;
presentably expressing the acquired status signal to the user if the acquired status signal does not match the stored status signal; and
registering relativity in the acquired status signal and a reaction signal from the user in response to the acquired status signal expressed.

20. A computer program product, comprising:
a computer readable program code embodied in said product for causing a computer to communicate with a home appliance, said computer readable program code comprising:
a first program code to acquire a status signal representing an operation status of the home appliance;
a second program code to presentably express the status signal to the user by the user's recognizable method;
a third program code to acquire a reaction signal by converting the user's reaction in response to the status signal expressed;
a fourth program code to register relativity in the status signal and the reaction signal;
a fifth program code to store the status signal and the reaction signal with the relativity in a memory;
a sixth program code to compare an acquired status signal to the stored status signal in the memory;
a seventh program code to presentably express the reaction signal related to the stored status signal to the user if the acquired status signal matches the stored status signal;
an eighth program code to presentably express the acquired status signal to the user if the acquired status signal does not match the stored status signal; and
a ninth program code to register relativity in the acquired status signal and a reaction signal from the user in response to the acquired status signal expressed.
